(19) United States
(12) Patent Application Publication
(10) Pub. No.: US 2026/0369727 A1
(43) Pub. Date: Nov. 19, 2026

(54) SURFACE MODIFIED FILMS FOR BONDING AN INFLATABLE COLD PLATE

(71) Applicant: GM Global Technology Operations LLC, Detroit, MI (US)

(72) Inventors: Mary Gilliam, Farmington Hills, MI (US); William Yu Chen, Troy, MI (US); Xingcheng Xiao, Troy, MI (US); Michael J. Lukitsch, Marysville, MI (US); Diptak Bhattacharya, Royal Oak, MI (US); Graham Garner, Grand Blanc, MI (US); Blair E. Carlson, Ann Arbor, MI (US); Andrew Clay Bobel, Troy, MI (US)

(21) Appl. No.: 19/207,633

(22) Filed: May 14, 2025

(51) Int. Cl. H01M 10/6554; H01M 10/613; H01M 10/625; H01M 10/647; H01M 10/6556; H01M 10/6568

(52) U.S. Cl. CPC H01M 10/6554; H01M 10/613; H01M 10/625; H01M 10/647; H01M 10/6556; H01M 10/6568

(57) ABSTRACT

A thermal management system comprising a plate comprising a first plate surface and a second plate surface opposite the first plate surface; one or more standoffs coupled to the plate; one or more cooling channels coupled to the plate, comprising: a film layer, comprising: a first film surface facing and selectively coupled to the plate via a bonded region, and a second film surface opposite the first film surface; and a fluid arranged between the first film surface and the plate, wherein the plate is subjected to one or more surface chemical modification treatments in the bonded region to ensure bonding to the first film surface, and wherein the first film surface is subjected to one or more surface chemical modification treatments in the bonded region to ensure bonding to the plate.

### INTRODUCTION

The subject disclosure relates to vehicles, and in particular to rechargeable energy storage systems (RESS's), or battery systems of vehicles.

RESS's are utilized to provide electrical power for propulsion and other functions of vehicle systems to which the RESS is connected. RESS's typically include a plurality of battery cells located in a battery enclosure. The battery cells and the battery enclosure define the RESS. Cooling systems are typically utilized to maintain a selected temperature of the battery cells inside the battery enclosure. Additionally, the battery enclosure is typically sealed to maintain a selected pressure of the battery cells in the battery enclosure. The typical cooling systems are often complex and limit options for order of assembly of the RESS structure.

Some RESS's can include one or more battery cells and one or more cooling channels arranged between or below the one or more battery cells. Thermal interface material (TIM) is commonly disposed between battery cells and thermal management systems in an existing RESS. However, consistent application of TIM can be difficult and thus, thermal performance of existing RESS's can vary. Shortcomings of existing systems are addressed by one or more aspects of the present disclosure.

### SUMMARY

In one exemplary embodiment a thermal management system includes a plate including a first plate surface and a second plate surface opposite the first plate surface. The thermal management system also includes one or more standoffs that are coupled to the plate, and one or more cooling channels that are coupled to the plate. The one or more cooling channels include a film layer that includes a first film surface that is facing and selectively coupled to the plate via a bonded region, and a second film surface that is opposite the first film surface. A fluid is arranged between the first film surface and the plate. The plate is subjected to one or more surface chemical modification treatments in the bonded region to ensure bonding to the first film surface. In addition, the first film surface is subjected to one or more surface chemical modification treatments in the bonded region to ensure bonding to the plate.

In addition to one or more of the features described herein, the one or more surface chemical modification treatments of the plate may include one or more of a laser chemical modification or a plasma chemical modification to the bonded region of the plate.

In addition to one or more of the features described herein, the one or more surface chemical modification treatments of the plate may include laser chemical modification of the bonded region of the plate, wherein the laser chemical modification may include one or more of laser cleaning or laser ablation by changing surface energy, microstructure, or surface chemistry to enhance chemical bonding between the plate and the first film surface in the bonded region.

In addition to one or more of the features described herein, the laser chemical modification may include the formation of an oxide layer, a hydroxide layer, or a combination thereof in the bonded region of the plate.

In addition to one or more of the features described herein, the one or more surface chemical modification treatments of the plate may include plasma chemical modification to the bonded region of the plate, wherein the plasma chemical modification enhances chemical bonding between the first film surface and the plate in the bonded region.

In addition to one or more of the features described herein, the one or more surface chemical modification treatments of the plate further may further include depositing a metal organic compound in the bonded region of the plate.

In addition to one or more of the features described herein, the metal organic compound may include Si, Al, Ce, Cu, Ge, Ti, Zr, or a combination thereof; an alkoxide group, a hydroxide group, or a combination thereof; and an alkyl group, an ether group, an acrylate group, an azide group, a vinyl group, an amino group, an epoxy group, an isocyanate group, a halogen, sulfur, or a combination thereof.

In addition to one or more of the features described herein, the one or more surface chemical modification treatments of the first film surface may include plasma chemical modification to the bonded region of the first film surface, wherein the plasma chemical modification increases oxidation number, provides polar functional groups, increases surface wetting, or a combination thereof.

In addition to one or more of the features described herein, the one or more surface chemical modification treatments of the first film surface may further include the formation of one or more functional groups in the bonded region of the first film surface, wherein the one or more functional groups may include triazine, (meth)acrylate, epoxy, amino, alcohol, vinyl, acid anhydride, or a combination thereof.

In addition to one or more of the features described herein, the one or more standoffs may be coupled to the first plate surface, the second plate surface, or a combination thereof.

In addition to one or more of the features described herein, the film layer may be coupled to the first plate surface.

In addition to one or more of the features described herein, the film layer includes a first film layer and a second film layer. The first film layer is coupled to the first plate surface and defines a first cooling pathway, and the second film layer is coupled to the second plate surface and defines a second cooling pathway.

In addition to one or more of the features described herein, the fluid may be a coolant.

In another exemplary embodiment a battery pack includes one or more battery cells and a thermal management system. The thermal management system includes a plate including a first plate surface and a second plate surface opposite the first plate surface. The thermal management system also includes one or more standoffs that are coupled to the plate, and one or more cooling channels that are coupled to the plate. The one or more cooling channels include a film layer that includes a first film surface that is facing and selectively coupled to the plate via a bonded region, and a second film surface that is opposite the first film surface. A fluid is arranged between the first film surface and the plate. The plate is subjected to one or more surface chemical modification treatments in the bonded region to ensure bonding to the first film surface. In addition, the first film surface is subjected to one or more surface chemical modification treatments in the bonded region to ensure bonding to the plate.

In addition to one or more of the features described herein, the film layer may include contact surfaces that are configured to engage with the one or more battery cells.

In addition to one or more of the features described herein, the one or more surface chemical modification treatments of the plate may include one or more of a laser chemical modification or a plasma chemical modification to the bonded region of the plate.

In addition to one or more of the features described herein, the one or more surface chemical modification treatments of the first film surface includes plasma chemical modification to the bonded region of the first film surface.

In yet another exemplary embodiment a vehicle includes a vehicle body including a first end, a second end spaced from the first end, a first side, and a second side spaced from the first side. A motor is coupled to the vehicle body, and a battery pack is coupled to the vehicle body and communicatively coupled to the motor. The battery pack includes one or more battery cells and a thermal management system. The thermal management system includes a plate including a first plate surface and a second plate surface opposite the first plate surface. The thermal management system also includes one or more standoffs that are coupled to the plate, and one or more cooling channels that are coupled to the plate. The one or more cooling channels include a film layer that includes a first film surface that is facing and selectively coupled to the plate via a bonded region, and a second film surface that is opposite the first film surface. A fluid is arranged between the first film surface and the plate. The plate is subjected to one or more surface chemical modification treatments in the bonded region to ensure bonding to the first film surface. In addition, the first film surface is subjected to one or more surface chemical modification treatments in the bonded region to ensure bonding to the plate.

In addition to one or more of the features described herein, the one or more surface chemical modification treatments of the plate may include one or more of a laser chemical modification or a plasma chemical modification to the bonded region of the plate.

In addition to one or more of the features described herein, the one or more surface chemical modification treatments of the first film surface includes plasma chemical modification to the bonded region of the first film surface.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a front perspective view of a vehicle including a battery pack and a motor according to one or more embodiments;

FIG. 2 is a front perspective view of a battery cell of the battery pack of FIG. 1;

FIG. 3 is a top perspective view of the battery pack of FIG. 1 including a thermal management system according to one or more embodiments;

FIG. 4. is a cross-sectional view of the battery pack of FIG. 3 along line 4-4;

FIG. 5 is a cross-sectional view of the battery pack of FIG. 3 including one or more inflated cooling channels;

FIG. 6 is a cross-sectional view of another configuration of the battery pack of FIG. 1 according to one or more embodiments;

FIG. 7 is a cross-sectional view of another configuration of a battery pack according to one or more embodiments;

FIG. 8 is a cross-sectional view of another configuration of a battery pack according to one or more embodiments;

FIG. 9 is a bar graph showing the energy absorbed to fail (N. m) for samples prepared according to Examples 1-4 and Comparative Example 1; and

FIG. 10 is a bar graph showing the peak load (N) for samples prepared according to Examples 1-4 and Comparative Example 1.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Some rechargeable energy storage systems (RESS) use thermal interface materials (TIMs) to fill air gaps between one or more battery cells and a cooling plate. TIMs can be used to regulate temperature of the one or more battery cells by contacting the battery cell to the cooling plate. However, consistent application of TIMs can be challenging and thus, thermal performance can vary.

Accordingly, these shortcomings, among others, are addressed by principles of the present disclosure.

In accordance with one or more embodiments described herein, surface chemical modification techniques are applied to a metal plate (e.g., a foil) and to a polymer film to create an inflatable cold plate for cooling electric vehicle battery cells, in which the metal plate and the polymer film are bonded in a pattern to create channels for the cooling fluid to flow. The metal plate and the polymer film are each surface chemically modified locally at the bond lines and joined under high temperature and pressure to bond the materials together, as described herein.

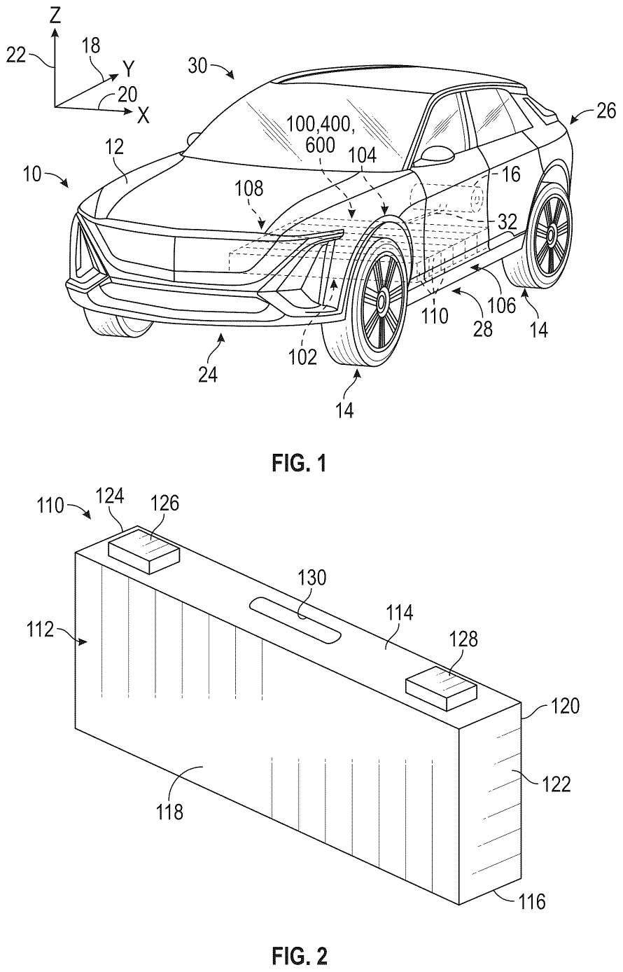

In accordance with an exemplary embodiment, a vehicle is shown at 10 in FIG. 1. The vehicle 10 includes a vehicle body 12, one or more wheels 14 coupled to the vehicle body 12, and an electric motor 16 arranged in and/or coupled to the vehicle body 12. The vehicle body 12 extends along a first or longitudinal axis (i.e., fore-aft direction) 18, a second or lateral axis (i.e., cross-car direction) 20, and a third or vertical axis 22. The vehicle body 12 can include a first or front end 24, a second or rear end 26 spaced from the front end 24 with respect to the longitudinal axis 18, a first or left side 28, and a second or right side 30 spaced from the left side 28 with respect to the lateral axis 20. The electric motor 16 can be configured to drive one or more of the one or more wheels 14 to propel the vehicle 10. The vehicle 10 includes a battery pack 100 that can be arranged in and/or coupled to the vehicle body 12 and is communicatively coupled to the electric motor 16 via an electric power cable 32.

The battery pack 100 extends at least along the longitudinal axis 18 and the lateral axis 20. The battery pack 100 can have a first or front end 102, a second or rear end 104 spaced from the front end 102 with respect to the longitudinal axis 18, a first or left side 106, and a second or right side 108 spaced from the left side 106 with respect to the lateral axis 20. In the present illustrative example, the battery pack 100 includes one or more battery cells 110 arranged between the front end 102 and the rear end 104.

With reference to FIG. 2, an illustrative example of one of the one or more battery cells 110 is provided. In the present illustrative example, the one or more battery cells 110 are prismatic battery cells, however, the principles of the present disclosure can equally apply to other types of battery cells, such as cylindrical battery cells. The one or more battery cells 110 can each include a prismatic can 112 that extends between a first or upper end 114 and a second or lower end 116. The prismatic can 112 includes one or more side walls, such as a first side wall 118 and a second side wall 120 spaced from the first side wall 118. Additionally, the prismatic can 112 includes a first end wall 122 and a second end wall 124. In the present example, the first and second side walls 118, 120 have a length that is longer than that of the first and second end walls 122, 124. The prismatic can 112 is configured to house battery internals, such as one or more jelly rolls (not shown). The one or more battery cells 110 include terminals coupled to the upper end 114 and in communication with the battery internals. The terminals can include a positive terminal 126 and a negative terminal 128, for example. In the present illustrative example, the prismatic can 112 includes a vent 130 that is arranged at the upper end 114 and between the positive terminal 126 and the negative terminal 128.

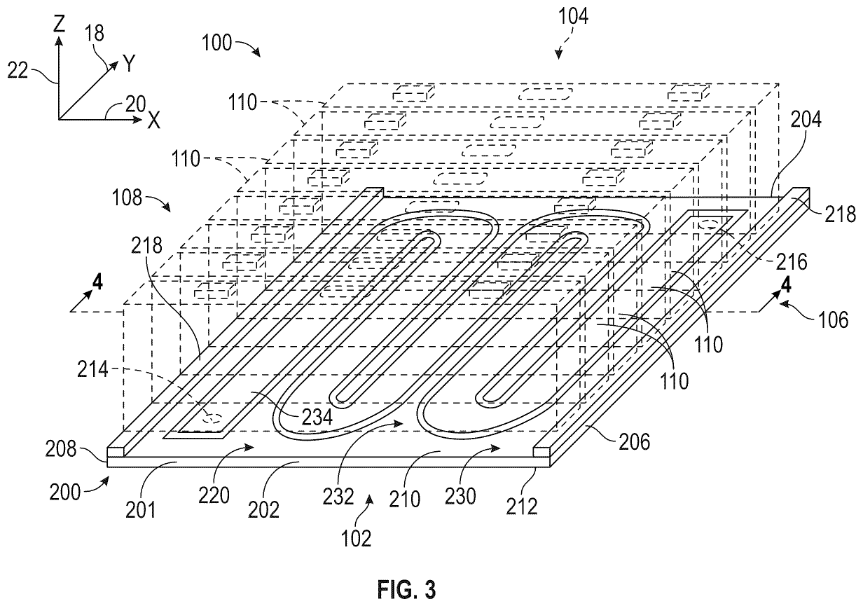

With reference to FIG. 3, the battery pack 100 can further include a thermal management system 200 arranged with respect to the one or more battery cells 110. The thermal management system 200 includes a plate (i.e., cold plate) 201 that extends between the front and rear ends 102, 104 and between the first and second sides 106, 108 of the battery pack 100. The plate 201 includes a first end 202, a second end 204 spaced from the first end 202, a first side 206, and a second side 208 spaced from the first side 206. The first end 202 can be arranged adjacent to the front end 102 of the battery pack 100 and the second end 204 can be arranged adjacent to the rear end 104 of the battery pack 100. The plate 201 includes a first or upper surface 210 and a second or lower surface 212 opposite the upper surface 210. In the present illustrative configuration, the upper surface 210 faces the lower ends 116 of the one or more battery cells 110. One or more conduits can be arranged in the plate 201 and extend through the upper and lower surfaces 210, 212 of the plate 201. The one or more conduits can include an inlet 214 and an outlet 216. In some configurations, the inlet 214 and the outlet 216 are arranged on the same side or same end of the plate 201 and, in other configurations, the inlet 214 and the outlet 216 are arranged on opposite sides or ends of the plate 201, as shown in FIG. 3.

The plate 201 is metallic. The metal can include at least one of aluminum, magnesium, iron, copper, gold, silver, nickel, or stainless steel. The metal can also include platings of one metal on another (for example, silver-plated copper), or bimetallic or layered metals (for example, aluminum and copper bonded sheets). In some embodiments, the plate 201 may include aluminum. For example, the plate 201 may include a partially recrystallized aluminum, which can facilitate uniform inflation of the cooling channel.

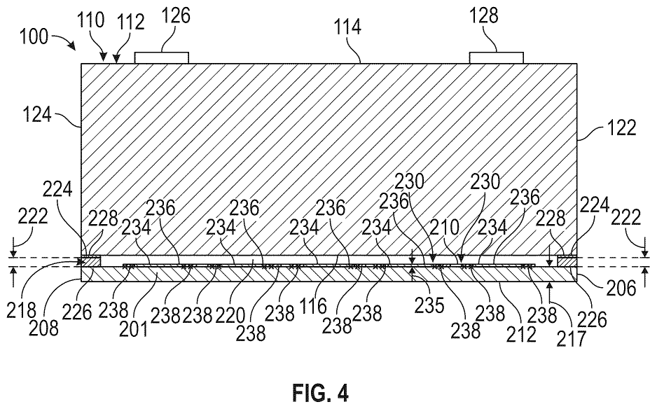

According to one aspect, the plate 201 can have a thickness 217 between 0.5 and 2 millimeters (mm), see for example FIG. 4. For example, the plate 201 may be in the form of a flexible foil, but embodiments are not limited thereto.

With continued reference to FIG. 3, the thermal management system 200 can include one or more standoffs 218 arranged between the one or more battery cells 110 and the plate 201. In general, the one or more standoffs 218 can be configured to establish and/or maintain separation between a portion of the plate 201 and the one or more battery cells 110. A gap or chamber 220 is formed between the plate 201 and the one or more battery cells 110. With reference to FIG. 4, the gap or chamber 220 can be defined by a thickness 222 between a first or top surface 224 and a second or bottom surface 226 opposite of the top surface 224. According to one aspect, the thickness 222 of the one or more standoffs 218 can be between 1 and 2 millimeters (mm). The one or more standoffs 218 can be arranged adjacent to or at the first and second sides 206, 208 and extend between the first end 202 and the second end 204 of the plate 201. In some configurations, the one or more standoffs 218 can include one or more points (e.g., circles, squares, etc.) rather than the linear arrangement shown in the illustrative configuration of FIG. 3. The bottom surface 226 of the one or more standoffs 218 can be coupled to or otherwise attached to a portion of the upper surface 210 of the plate 201.

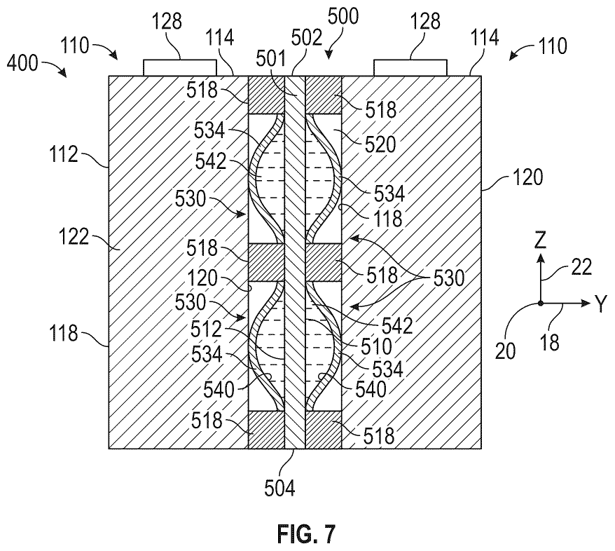

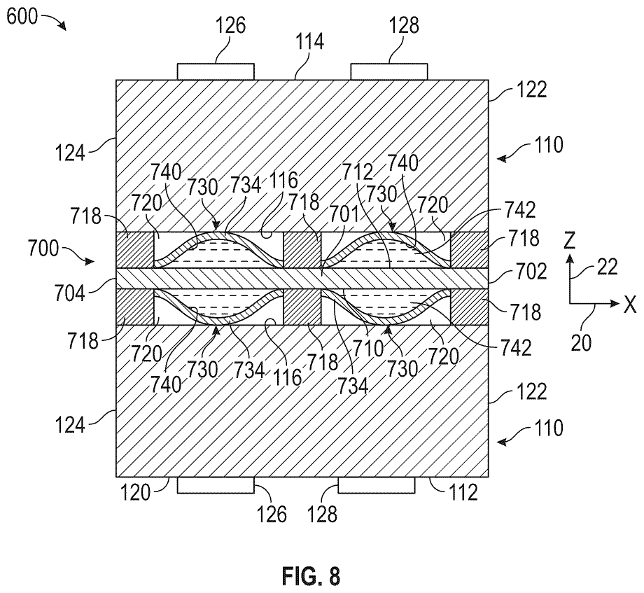

In some configurations (FIGS. 7 and 8), as will be discussed in more detail below, the one or more standoffs 218 can also be arranged on the lower surface 212 of the plate 201 as well. The top surface 224 of the one or more standoffs 218 can be coupled to or otherwise attached to a portion of the lower end 116 of the prismatic can 112 of the one or more battery cells 110.

An adhesive, heat welding, laser welding, spot welding, TIG welding, or another coupling technique commonly used in manufacturing automotive battery cells may be used to couple or otherwise attach the one or more standoffs 218 to the plate 201 and/or to the one or more battery cells 110. In another configuration, at least one of the one or more standoffs 218 can be an integral component of the plate 201. For instance, at least one of the one or more standoffs 218 can be formed with the plate 201 during an injection molding process. In another configuration, at least one of the one or more standoffs 218 are either an integral portion, coupled to, or otherwise attached to the lower end 116 of the prismatic can 112. For example, at least one of the one or more standoffs 218 can be metallic and can be welded via a laser to a portion of the prismatic can 112. For instance, in the present illustrative example, an adhesive 228 is arranged between the top surface 224 of the one or more standoffs 218 and the one or more battery cells 110.

With continued reference to FIGS. 3 and 4, the thermal management system 200 includes one or more cooling channels (hereinafter, the cooling channels) 230 arranged on the upper surface 210 of the plate 201. As discussed in more detail below with respect to other configurations, the cooling channels 230 can also be arranged on the lower surface 212 of the plate 201. The cooling channels 230 can be communicatively coupled to the one or more conduits (e.g., the inlet 214 and outlet 216) and arranged in a serpentine path (FIG. 3) 232, in parallel columns, or in another configuration. According to one aspect, the cooling channels 230 can occupy more than half of the surface area of the upper surface 210. The cooling channels 230 include a film layer 234 that is coupled to or otherwise attached to the upper surface 210 of the plate 201.

The film layer 234 can be any suitable material. For example, the film layer 234 can include a silicone polymer, an elastomer, a polyolefin, a polyvinyl chloride, a polystyrene, a polyamide (for example, nylon), a polyimide, a polyurethane, a polyester (for example, poly(ethylene terephthalate)), or the like, or a combination thereof. In some embodiments, the film layer 234 may include a polyamide (PA), a polyphthalamide (PPA), polypropylene (PP), a polyurethane (PU), polyethylene terephthalate (PET), or the like, or a combination thereof.

The film layer 234 can be coupled to the plate 201 using any suitable method that includes heat and/or pressure. For example, the film layer 234 may be coupled to the plate 201 using impulse heat sealing, heat stamping, heat rolling, laser, or infrared light, for example. The coupling may be conducted at any suitable temperature and at any suitable pressure.

According to one aspect, the film layer 234 can include a thickness 235 that is between 40 and 200 micrometers (um). Upon assembly, the film layer 234 includes two or more unbonded regions 236 and two or more bonded regions 238. As will be discussed in further detail herein, the bonded regions 238 include a bond between the layers that is strengthened due to the one or more surface chemical modification treatments that are performed to the surface of the plate 201 in this region, and due to the one or more surface chemical modification treatments that are performed to the film layer 234 in this region. In some embodiments, the surface treated region (chemically modified region) of the plate 201 and the surface treated region (chemically modified region) of the film layer 234 define the bonded regions 238.

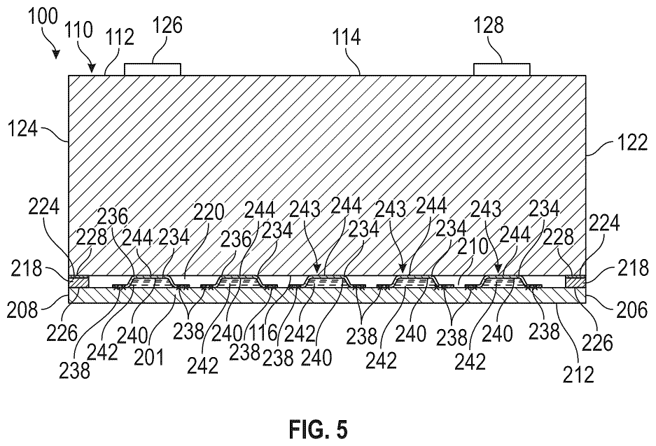

With reference to FIG. 5, a coolant pathway 240 can be defined between the one or more unbonded regions 236, the one or more bonded regions 238, and the plate 201. A fluid, such as a coolant 242 (e.g., a blend of Dexcool® and water, ethylene glycol/water-based coolants, hydrocarbon oils, silicone oils, ethers, fluorocarbon oils, ethanol, methanol, ammonia, water, air, nitrogen, or the like), can be arranged in the coolant pathway 240 to inflate the film layer 234. An operating pressure can be between 100-200 kilopascals (kPa) or 15-30 pounds per square inch (psi). The operating pressure applies an outward force away from the plate 201 so that the contact surfaces 244 of the film layer 234 directly engage with or press against the one or more battery cells 110. In other words, one or more thermal pathways 243 are established between the film layer 234 and the one or more battery cells 110 upon inflation, which eliminates the need for TIM. This can be desirable because TIM can be expensive and/or can add a considerable amount of weight to existing RESS. According to one configuration, prior to inflation, an adhesive can be applied to the one or more contact surfaces 244 so that the film layer 234 adheres to the one or more battery cells 110 upon inflation. In another configuration, a minimum pressure (e.g., 1 psi) can be maintained within the cooling pathways 240 so that the film layer 234 has a minimum set shape, for example. This can be desirable so that the cooling channels 230 can easily inflate during operation, for example.

To ensure adhesion between the first film surface and the upper surface 210 of the plate 201 in the bonded region 238, the plate 201 is subjected to one or more surface chemical modification treatments in the bonded region 238 to ensure bonding to the first film surface of the film layer 234, and the first film surface of the film layer 234 is subjected to one or more surface chemical modification treatments in the bonded region 238 to ensure bonding to the upper surface 210 of the plate 201.

In some embodiments, the one or more surface chemical modification treatments of the plate 201 (e.g., the first plate surface) includes one or more of a laser chemical modification or a plasma chemical modification to the bonded region 238 of the plate 201. For example, the one or more surface chemical modification treatments of the plate 201 can include laser chemical modification of the bonded region 238 of the plate 201, wherein the laser chemical modification includes one or more of laser cleaning or laser ablation by changing surface energy, microstructure, or surface chemistry to enhance chemical bonding between the surface of the plate 201 and the first film surface of the film layer 234 in the bonded region 238. The laser chemical modification may include, for example, laser cleaning, laser ablation, laser resurfacing, and/or laser restructuring. For laser chemical modification the laser parameters are set such that a heat-treated plate does not significantly alter the grain structure due to thermal load from the laser treatment. Additionally or alternatively, the laser chemical modification parameters may be varied depending on the areas of the plate that have been work hardened and those which have not. The laser cleaning removes contaminants from the surface of the plate 201 so they are not present during the bonding of the first film surface of the film layer 234 to the plate 201. Additionally, laser ablation may be performed to bring about a higher surface energy of the metal material of the plate 201.

In some embodiments, the laser ablation may be applied to the surface of the plate 201 to create oxide and/or hydroxide functionality. For example, laser ablation may be applied with a fluence from 5-30 Joules per square centimeter (J/cm²) to cause the surface of the plate 201 to melt, resolidify, and to form a metal oxide/metal hydroxide layer. (E.g., an aluminum oxide/aluminum hydroxide layer). Other parameters of the laser ablation may include a pulse overlap range of 25-65% for a round beam and 5-25% for a square top-hat beam, and a line overlap >0% in all treated areas.

In some embodiments, laser cleaning may be used to clean and flatten the surface of the plate 201. For example, laser cleaning may be applied with a fluence from 3-6 J/cm², a pulse overlap range of 25-50% for a Gaussian beam and 0-25% for a square top-hat beam, and a line overlap of 0-25% in all treated areas.

Following laser chemical modification, additional chemical surface modification may be applied to the surface of the plate 201 that has been laser treated. For example, a chemical precursor may be applied to the laser ablated surface of the plate 201 using dip, spray, brush, plasma deposition, or other such coating techniques. The further chemical modification may be accomplished using a metal-organic compounds, such as those including a metal selected from Si, Al, Ce, Cu, Ge, Ti, or Zr, bonded to one or more alkoxide or hydroxide groups and/or one or more organic groups, such as an alkyl, ether, acrylate, azide, vinyl, amine, epoxy, isocyanate, or a group containing a halogen or sulfur. For example, an aminosilane or an epoxysilane may be grafted onto the surface of the laser-treated plate 201. For example, an aminosilane may be grafted onto the surface of the laser-treated plate 201 to provide an amine functionality to the surface, or for example, an epoxysilane may be grafted onto the surface of the laser-treated plate 201 to provide an epoxy functionality to the surface.

Additionally, or alternatively, the plasma chemical modification may be utilized to create a chemical bond between a surface of the plate 201 and the first film surface of the film layer 234. The plasma chemical modification increases the surface energy and may include the creation of a thin film or coating on a surface of the plate 201. In some embodiments, the one or more surface chemical modification treatments of the plate 201 includes plasma chemical modification to the bonded region 238 of the plate 201, wherein the plasma chemical modification enhances chemical bonding between the first film surface of the film layer 234 and a surface of the plate 201 in the bonded region 238. In some embodiments, a surface of the plate 201 may be chemically modified at the bonded region 238 using plasma processing, in which atmospheric pressure plasma surface treatment is applied using air, nitrogen, argon, or a combination of such gases, and subsequently is characterized by increased oxidation, the formation of polar functional groups, and/or a higher surface energy.

In some embodiments, the plasma modified surface of the plate 201 is subsequently chemically modified by application of a thin film. The thin film may be prepared using one or more precursors. Exemplary precursors include a metal, such as Si, Al, Ce, Cu, Ge, Ti, or Zr, bonded to one or more alkoxide groups or hydroxide groups, and/or one or more organic groups, such as an alkyl, an ether, an acrylate, an azide, a vinyl, an amine, an epoxy, an isocyanate, or a group containing a halogen or sulfur. The chemical modification of the plasma-modified surface of the plate 201 may be accomplished using any one of dipping, spraying, brushing, or other such coating techniques.

In some embodiments, the plasma chemically modified surface of the plate 201 is subsequently further chemically modified by application of a thin film using a plasma process. In such embodiments, a chemical precursor is injected into the plasma stream to chemically modify the surface of the plate 201 with various chemical functionalities, such as those described herein.

The first film surface of the film layer 234 is subjected to one or more surface chemical modification treatments in the bonded region 238 to ensure bonding to a surface of the plate 201. Plasma chemical modification treatment may be utilized to create a chemical bond between a surface of the plate 201 and the first film surface of the film layer 234. For example, plasma chemical modification treatment may be used to chemically modify the bonded region 238 of the first film surface of the film layer 234 by atmospheric pressure plasma surface treatment with air, nitrogen, argon, or a combination of such gases to increase oxidation, increase polar functional groups, and/or increase surface energy of the first film surface of the film layer 234 to tailor wetting and bonding of the film precursor to a surface of the plate 201 in the bonded region 238.

In some embodiments, the plasma-modified first film surface of the film layer 234 may be subsequently further chemically modified with a functional group. For example, the plasma-modified first film surface of the film layer 234 may be modified by chemical methods to include a functional group selected from triazine, acrylate, methacrylate, epoxy, amine, alcohol (—OH), vinyl, acid anhydride, or the like, or a combination thereof. The chemical modification of the plasma-modified first film surface of the film layer 234 may be accomplished by application of a chemical precursor through dipping, spraying, brushing, or other such techniques. In still other embodiments, the chemical modification of the plasma-modified first film surface of the film layer 234 may be accomplished using a plasma method, wherein a suitable precursor in injected into the plasma stream to form a thin layer on the surface of the film layer 234 of plasma-derived chemical functional groups.

The functional groups on the chemically modified surface of the film layer 234 are selected to be compatible with the functional groups on the chemically modified surface of the plate 201, such that bonding is improved between the film layer 234 and the plate 201. In some embodiments, the functional groups on the chemically modified surface of the film layer 234 may be covalently bonded to the functional groups on the chemically modified surface of the plate 201. In some embodiments, the functional groups on the chemically modified surface of the film layer 234 may be bonded via hydrogen bonding to the functional groups on the chemically modified surface of the plate 201. In still other embodiments, the functional groups on the chemically modified surface of the film layer 234 may be bonded by a combination of both covalent and hydrogen bonding to the functional groups on the chemically modified surface of the plate 201.

Since the plate 201 is subjected to one or more surface chemical modification treatments in the bonded region 238 to ensure bonding to the first film surface of the film layer 234, and the first film surface of the film layer 234 is subjected to one or more surface chemical modification treatments in the bonded region 238 to ensure bonding to the plate 201, there is a significant improvement in the adhesion between layers. In some embodiments, the energy absorbed to fail after surface chemical modification treatments may be greater than 20 Newton millimeters (N. mm). For example, the energy absorbed to fail after surface chemical modification treatment may be from 20 to 60 N. mm, or from 20 to 50 N. mm, or from 20 to 40 N. mm, but embodiments are not limited thereto. In some embodiments, the peak load after surface chemical modification treatments may be greater than 3 N. For example, the peak load after surface chemical modification treatments may be from 3 to 10 N, or from 3 to 8 N, or from 3 to 6 N, but embodiments are not limited thereto.

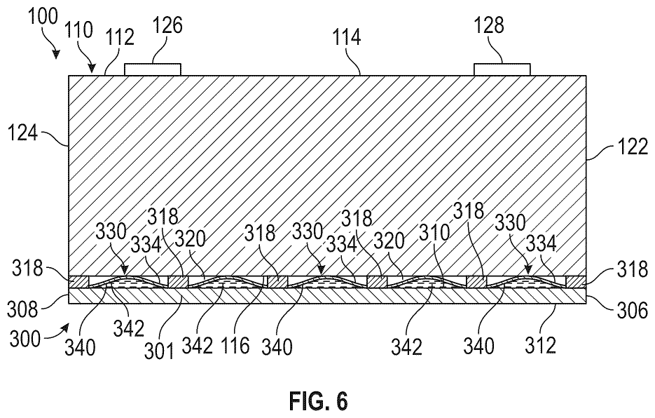

FIG. 6 illustrates another exemplary configuration of a thermal management system 300. This configuration is similar in many respects to the configurations of FIGS. 1-5. Accordingly, the descriptions of the configurations are hereby incorporated into one another, and description of subject matter common to the configurations generally may not be repeated.

With reference to FIG. 6, the thermal management system 300 includes a plate 301 that extends between a first side 306 and a second side 308. A first or upper surface 310 and a second or lower surface 312 each extend between the first side 306 and the second side 308. One or more standoffs 318 are coupled to the upper surface 310 between the first side 306 and the second side 308 and maintain a gap or chamber 320 between the plate 301 and one or more battery cells 110. One or more cooling channels 330 are arranged in the gap 320. More particularly, the cooling channels 330 include a film layer 334 coupled to or otherwise attached to the upper surface 310 of the plate 301. Both the film layer 334 and the upper surface 310 of the plate 301 have chemically modified surfaces in the bonded regions, as described herein. A cooling pathway 340 is defined between the film layer 334 and the plate 301 and is configured to receive and carry a fluid, such as a coolant 342. In the present illustrative configuration, the one or more standoffs 318 are arranged between the cooling channels 330. This can be desirable to maintain the gap 320 so that the film layer 334 and, more specifically, the cooling pathway 340 is not compressed during or after operation, for example.

FIG. 7 illustrates another exemplary configuration of a battery pack 400. This configuration is similar in many respects to the configuration of FIGS. 1-5 and FIG. 6. Accordingly, the descriptions of the configurations are hereby incorporated into one another, and description of subject matter common to the configurations generally may not be repeated.

With reference to FIG. 7, the battery pack 400 includes a thermal management system 500 arranged between the one or more battery cells 110 with respect to the lateral axis 20. The thermal management system 500 includes a plate 501 having a first end 502 and a second end 504 opposite the first end 502. A first side surface 510 extends between the first end 502 and the second end 504 and faces the first side wall 118 of at least one of the one or more battery cells 110. A second side surface 512 is arranged opposite of the first side surface 510 and extends between the first end 502 and the second end 504. Additionally, the second side surface 512 faces the second side wall 120 of at least one of the one or more battery cells 110. One or more standoffs 518 are coupled to or otherwise attached to the first side surface 510 and the second side surface 512 of the plate 501. The one or more standoffs 518 establish and/or maintain a gap 520 between the one or more battery cells 110 and the first and second side surfaces 510, 512.

With reference again to FIG. 7, one or more cooling channels 530 can be arranged within the gap 520 between the one or more battery cells 110 and the first and second side surfaces 510, 512. The one or more cooling channels 530 include a film layer 534 that is attached or otherwise coupled to the first and second side surfaces 510, 512. Both the film layer 534 and the first and second side surfaces 510, 512 of the plate 501 have chemically modified surfaces in the bonded regions, as described herein. The film layer 534 can be selectively coupled or otherwise attached to the plate 501 to define one or more cooling pathways 540. A fluid, such as a coolant 542, can be circulated within the cooling pathways 540 so that a portion of the film layer 534 engages with and/or contacts the one or more battery cells 110, for example.

FIG. 8 illustrates another exemplary configuration of a battery pack 600. This configuration is similar in many respects to the configuration of FIGS. 1-5, FIG. 6, and FIG. 7. Accordingly, the descriptions of the configurations are hereby incorporated into one another, and description of subject matter common to the configurations generally may not be repeated.

With reference to FIG. 8, the battery pack 600 includes a thermal management system 700 arranged between the one or more battery cells 110 with respect to the vertical axis 22. The thermal management system 700 includes a plate 701 having a first end 702 and a second end 704 opposite the first end 702 with respect to the lateral axis 20. A first side surface 710 extends between the first end 702 and the second end 704 and faces the lower end 116 of at least one of the one or more battery cells 110. A second side surface 712 is arranged opposite of the first side surface 710 and extends between the first end 702 and the second end 704. Additionally, the second side surface 712 faces the lower end 116 of another one of the one or more battery cells 110. Thus, the thermal management system is sandwiched between the lower ends 116 of two or more of the battery cells 110 along the longitudinal axis (extending into the page). One or more standoffs 718 are coupled to or otherwise attached to the first side surface 710 and the second side surface 712 of the plate 701. The one or more standoffs 718 establish and/or maintain a gap 720 between the one or more battery cells 110 and the first and second side surfaces 710, 712.

With reference again to FIG. 8, one or more cooling channels 730 can be arranged within the gap 720 between the one or more battery cells 110 and the first and second side surfaces 710, 712. The one or more cooling channels 730 include a film layer 734 that is attached or otherwise coupled to the first and second side surfaces 710, 712. The film layer 734 can be selectively coupled or otherwise attached to the plate 701 to define one or more cooling pathways 740. Both the film layer 734 and the first and second side surfaces 710, 712 of the plate 701 have chemically modified surfaces in the bonded regions, as described herein. A fluid, such as a coolant 742, can be circulated within the cooling pathways 740 so that a portion of the film layer 734 engages with and/or contacts the one or more battery cells 110 and, more particularly, the portion of the lower ends 116, for example.

Yet another aspect provides a method of creating an inflatable cold plate with inner channels for flowing a cooling fluid, wherein a chemically modified plate and a chemically modified polymer film are bonded in targeted regions to create the channel pattern by applying force at the bonding surfaces sufficient to prevent cross flow of fluid, subsequently inflating the channels with a fluid to create tension in the polymer, and applying heat that is sufficient to soften or melt the polymer and initiate bonding between the chemically modified surfaces.

Still another aspect provides a method of creating an inflatable cold plate with inner channels for flowing a cooling fluid, wherein a spacer formed in the shape of the bonded area is disposed between the polymer film and the battery cells, such that the spacer protects the bonded area in compression, and prevents collapse of the channels due to the weight of the cells.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

### EXAMPLES

In the following examples, surface chemically modified aluminum foil and surface chemically modified PP films were bonded under high pressure and temperature to provide a bonded region between the layers.

### Example 1

An aluminum foil bonding surface was cleaned and flattened using a laser treatment, which was then followed by laser ablation of the bonding surface. A PP film was plasma treated with nitrogen, and the PP film surface was then functionalized using a triazine. The surface chemically modified aluminum foil and the surface chemically modified PP film were then bonded together under heat and pressure.

### Example 2

An aluminum foil bonding surface was cleaned and flattened using a laser treatment, which was then followed by laser ablation of the bonding surface. The laser treated aluminum foil bonding surface was then further treated with an aminosilane. A PP film was plasma treated with nitrogen. The surface chemically modified aluminum foil and the surface chemically modified PP film were then bonded together under heat and pressure.

### Example 3

An aluminum foil bonding surface was cleaned and flattened using a laser treatment, which was then followed by laser ablation of the bonding surface. The laser treated aluminum foil bonding surface was then further treated with an epoxysilane. A PP film was plasma treated with air. The surface chemically modified aluminum foil and the surface chemically modified PP film were then bonded together under heat and pressure.

### Example 4

An aluminum foil bonding surface was cleaned and flattened using a laser treatment, which was then followed by laser ablation of the bonding surface. A PP film was plasma treated with air, and the PP film surface was then functionalized using a triazine. The surface chemically modified aluminum foil and the surface chemically modified PP film were then bonded together under heat and pressure.

### Comparative Example 1

An unmodified aluminum foil and an unmodified PP film were bonded together under heat and pressure. Neither the aluminum foil plate nor the PP film were chemically modified at their surfaces.

### Bond Strength Evaluation

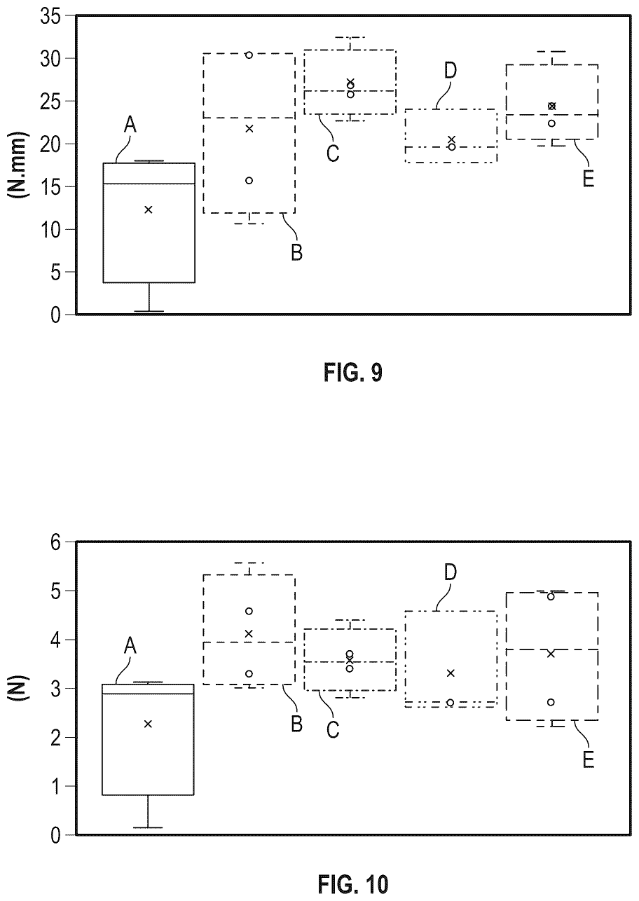

For Examples 1-4 and Comparative Example 1, the adhesion strength was evaluated using tensile testing equipment and was based on the energy absorbed to fail (N. mm) and peak load at fail (N). FIG. 9 shows the results of the energy absorbed to fail for each of Examples 1-4 (B, C, D, and E, respectively) and Comparative Example 1 (A). In each case, the energy absorbed to fail for Examples 1-4 exceeded the energy absorbed to fail for Comparative Example 1. FIG. 10 shows the results of the peak load at fail for each of Examples 1-4 (B, C, D, and E, respectively) and Comparative Example 1 (A). In each case, the peak load at fail for Examples 1-4 exceeded the peak load at fail for Comparative Example 1.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A thermal management system, comprising:
a plate comprising a first plate surface and a second plate surface opposite the first plate surface;
one or more standoffs coupled to the plate;
one or more cooling channels coupled to the plate, comprising:
a film layer, comprising:
a first film surface facing and selectively coupled to the plate via a bonded region, and
a second film surface opposite the first film surface; and
a fluid arranged between the first film surface and the plate,
wherein the plate is subjected to one or more surface chemical modification treatments in the bonded region to ensure bonding to the first film surface, and
wherein the first film surface is subjected to one or more surface chemical modification treatments in the bonded region to ensure bonding to the plate.

2. The thermal management system of claim 1, wherein the one or more surface chemical modification treatments of the plate comprise one or more of a laser chemical modification or a plasma chemical modification to the bonded region of the plate.

3. The thermal management system of claim 2, wherein the one or more surface chemical modification treatments of the plate comprises laser chemical modification of the bonded region of the plate, wherein the laser chemical modification comprises one or more of laser cleaning or laser ablation by changing surface energy, microstructure, or surface chemistry to enhance chemical bonding between the plate and the first film surface in the bonded region.

4. The thermal management system of claim 3, wherein the laser chemical modification comprises formation of an oxide layer, a hydroxide layer, or a combination thereof in the bonded region of the plate.

5. The thermal management system of claim 2, wherein the one or more surface chemical modification treatments of the plate comprises plasma chemical modification to the bonded region of the plate, wherein the plasma chemical modification enhances chemical bonding between the first film surface and the plate in the bonded region.

6. The thermal management system of claim 2, wherein the one or more surface chemical modification treatments of the plate further comprises depositing a metal organic compound in the bonded region of the plate.

7. The thermal management system of claim 6, wherein the metal organic compound comprises:
Si, Al, Ce, Cu, Ge, Ti, Zr, or a combination thereof;
an alkoxide group, a hydroxide group, or a combination thereof; and
an alkyl group, an ether group, an acrylate group, an azide group, a vinyl group, an amino group, an epoxy group, an isocyanate group, a halogen, sulfur, or a combination thereof.

8. The thermal management system of claim 1, wherein the one or more surface chemical modification treatments of the first film surface comprises plasma chemical modification to the bonded region of the first film surface, wherein the plasma chemical modification increases oxidation number, provides polar functional groups, increases surface wetting, or a combination thereof.

9. The thermal management system of claim 8, wherein the one or more surface chemical modification treatments of the first film surface further comprises formation of one or more functional groups in the bonded region of the first film surface, wherein the one or more functional groups comprise triazine, (meth)acrylate, epoxy, amino, alcohol, vinyl, acid anhydride, or a combination thereof.

10. The thermal management system of claim 1, wherein the one or more standoffs are coupled to the first plate surface, the second plate surface, or a combination thereof.

11. The thermal management system of claim 1, wherein the film layer is coupled to the first plate surface.

12. The thermal management system of claim 1, wherein the film layer comprises a first film layer and a second film layer, wherein the first film layer is coupled to the first plate surface and defines a first cooling pathway, and the second film layer is coupled to the second plate surface and defines a second cooling pathway.

13. The thermal management system of claim 1, wherein the fluid is a coolant.

14. A battery pack, comprising:
one or more battery cells; and
a thermal management system, comprising:
a plate comprising a first plate surface and a second plate surface opposite the first plate surface;
one or more standoffs coupled to the plate;
one or more cooling channels coupled to the plate, comprising:
a film layer, comprising:
a first film surface facing and selectively coupled to the plate via a bonded region, and
a second film surface opposite the first film surface; and
a fluid arranged between the first film surface and the plate,
wherein the plate is subjected to one or more surface chemical modification treatments in the bonded region to ensure bonding to the first film surface, and
wherein the first film surface is subjected to one or more surface chemical modification treatments in the bonded region to ensure bonding to the plate.

15. The battery pack of claim 14, wherein the film layer comprises contact surfaces configured to engage with the one or more battery cells.

16. The battery pack of claim 14, wherein the one or more surface chemical modification treatments of the plate comprise one or more of a laser chemical modification or a plasma chemical modification to the bonded region of the plate.

17. The battery pack of claim 14, wherein the one or more surface chemical modification treatments of the first film surface comprises plasma chemical modification to the bonded region of the first film surface.

18. A vehicle, comprising:
a vehicle body comprising a first end, a second end spaced from the first end, a first side, and a second side spaced from the first side;
a motor coupled to the vehicle body; and
a battery pack coupled to the vehicle body and communicatively coupled to the motor, the battery pack comprising:
one or more battery cells; and
a thermal management system, comprising:
a plate comprising a first plate surface and a second plate surface opposite the first plate surface;
one or more standoffs coupled to the plate;
one or more cooling channels coupled to the plate, comprising:
a film layer, comprising:
a first film surface facing and selectively coupled to the plate via a bonded region, and
a second film surface opposite the first film surface; and
a fluid arranged between the first film surface and the plate,
wherein the plate is subjected to one or more surface chemical modification treatments in the bonded region to ensure bonding to the first film surface, and
wherein the first film surface is subjected to one or more surface chemical modification treatments in the bonded region to ensure bonding to the plate.

19. The vehicle of claim 18, wherein the one or more surface chemical modification treatments of the plate comprise one or more of a laser chemical modification or a plasma chemical modification to the bonded region of the plate.

20. The vehicle of claim 18, wherein the one or more surface chemical modification treatments of the first film surface comprises plasma chemical modification to the bonded region of the first film surface.
